(19) United States
(12) Patent Application Publication
(10) Pub. No.: US 2010/0043006 A1
(43) Pub. Date: Feb. 18, 2010

(54) SYSTEMS AND METHODS FOR A CONFIGURABLE DEPLOYMENT PLATFORM WITH VIRTUALIZATION OF PROCESSING RESOURCE SPECIFIC PERSISTENT SETTINGS

(75) Inventors: Robert Michael OAKES, Somerville, MA (US); Gernot SEIDLER, Foxboro, MA (US); Neil Alexander HALEY, Hudson, MA (US)

Correspondence Address: WILMERHALE/BOSTON, 60 STATE STREET, BOSTON, MA, 02109, US

(73) Assignee: EGENERA, INC., Marlborough, MA (US)

(21) Appl. No.: 12/190,930

(22) Filed: Aug. 13, 2008

(51) Int. Cl. G06F 9/00; G06F 9/46

(52) U.S. Cl. 718/104; 713/2

(57) ABSTRACT

Methods and systems for deploying a processing resource in a configurable platform are described. A methods includes providing a specification that describes a configuration of a processing area network, the specification including (i) a number of processors for the processing area network (ii) a local area network topology defining interconnectivity and switching functionality among the specified processors of the processing area network, and (iii) a storage space for the processing area network. The specification further includes processing resource specific persistent settings. The method further includes allocating resources from the configurable platform to satisfy deployment of the specification, programming interconnectivity between the allocated resources and processing resources to satisfy the specification, and deploying the specification to a processing resource within the configurable deployment platform in response to software commands. The specification is used to generate the software commands to configure the platform and deploy processing resources corresponding to the specification.

### BACKGROUND OF THE INVENTION

1. Field of the Invention

The invention relates to a configurable deployment platform with virtualization of processing resource specific persistent settings, and more specifically to a more accurate deployment specification containing such settings that can be automatically and dynamically installed to processing resources within a configurable deployment platform when desired.

2. Description of the Related Art

Enterprises have been continuing the move away from using expensive and slow mainframe computers to run their businesses. Corporate data centers are now filling with dozens to thousands of separate computers, called servers, which are deployed individually or in small clusters to host the many applications and business processes of the enterprise. The expense and delay of purchasing, installing, and configuring these individual computers has created a market for virtualized computing platforms. In contrast to computers configured with hardware and software to be dedicated to one application, virtualized computing platforms contain processor and memory resources that can be deployed or redeployed from one application to the next quickly and completely automatically.

In the past, the booting process for servers started with a check of a specific memory address immediately upon power up. The server would then start executing instructions at this memory address. This memory address normally contains a reference to the main part of the basic input output system (BIOS) responsible for booting the server and transferring control to the operating system. The BIOS does this by accessing the boot device (e.g. a hard disk, network location, removable disk drive) and having the CPU execute instructions from the boot device. These instructions on the boot device load the operating system, which then checks the hardware and loads the necessary device drivers and user interfaces.

During the booting process, the BIOS and the operating system use settings stored in non-volatile random access memory (NVRAM) to properly boot and configure the server. For example, NVRAM settings may be checked by the BIOS to determine which boot device to try to boot from first. As another example, NVRAM settings may instruct the BIOS to enable or disable certain CPU features.

In contrast to an individual server, a bladeframe based processing platform provides a large pool of processors from which a subset may be selected and configured through software commands to form a virtualized network of computers (“processing area network” or “processor clusters”) that may be deployed to serve a given set of applications or customer. The virtualized processing area network (PAN) may then be used to execute customer specific applications, such as web-based server applications. The virtualization may include virtualization of local area networks (LANs) or the virtualization of input-output (I/O) storage. By providing such a platform, processing resources may be deployed rapidly and easily through software via configuration commands, e.g., from an administrator, rather than through physically providing servers, cabling network and storage connections, providing power to each server and so forth.

An example platform is shown in FIG. 1, a preferred hardware platform 100 includes a set of processing nodes 105a-n connected to switch fabrics 115a,b via high-speed, interconnect 110a,b. The switch fabric 115a,b is also connected to at least one control node 120a,b that is in communication with an external IP network 125 (or other data communication network), and with a storage area network (SAN) 130. A management application 135, for example, executing remotely, may access one or more of the control nodes via the IP network 125 to assist in configuring the platform 100 and deploying virtualized PANs.

Processing nodes 105a-n, two control nodes 120, and two switch fabrics 115a,b can be contained in a single chassis and interconnected with a fixed, pre-wired mesh of point-to-point links. Each processing node 105 is a board that includes one or more (e.g., 4) processors 106j-l, one or more network interface cards (NICs) 107, and local memory (e.g., greater than 4 Gbytes) that, among other things, includes some BIOS firmware for booting and initialization. There is no local disk for the processors 106; instead all storage, including storage needed for paging, is handled by SAN storage devices 130.

Each control node 120 is a single board that includes one or more (e.g., 4) processors, local memory, and local disk storage for holding independent copies of the boot image and initial file system that is used to boot operating system software for the processing nodes 105 and for the control nodes 106. Each control node is connected to SAN 130 adapter cards 128 and links 122,124 and communicates with the Internet (or any other external network) 125 via an external network interface 129. Each control node can also include a low speed connection (not shown) as a dedicated management port, which may be used instead of remote, web-based management via management application 135.

Under software control, the platform supports multiple, simultaneous and independent processing areas networks (PANs). Each PAN, through software commands, is configured to have a corresponding subset of processors 106 that may communicate via a virtual local area network that is emulated over the point to point mesh. Each PAN is also configured to have a corresponding virtual I/O subsystem. No physical deployment or cabling is needed to establish a PAN.

In the virtualized computer platform described above I/O devices are moved to the edge of the platform, where they can be shared by all the processing resources through the switch fabric. The act of plugging an I/O card into a discrete computer, which might take hours or days in a traditional data center, is replaced by programming a route through the fabric from a server resource to an edge I/O device, which takes only an instant and can be performed completely automatically.

Automatic deployment of a PAN can be performed via the control node using a detailed deployment specification. The specification has a defined set of variables with corresponding values for the variables and is stored in a secure way, either at the control node 120 or in remote storage. The set of information that characterizes the PAN (i.e., the resource's “personality”), and that can be stored in the detailed deployment specification, includes logical information such as, the number of nodes that should be allocated, the network connectivity among processors, storage mappings and the like. The deployment specification is accessed and used to issue a set of commands on the configurable platform to instantiate processing resources consistent with the specification. Using the above approach, the detailed deployment specification can be used to rapidly deploy (or instantiate) a processor network. In this fashion, the configurable processing platform can be deployed quickly and in a way less susceptible to human error.

One problem with the above approach is that the processing nodes of the bladeframe processor network still contain NVRAM that is used by the BIOS and the operating system. When automatically deploying a PAN using a detailed deployment specification, the NVRAM settings of an application are not similarly deployed. At the point in the boot process where the deployment specification is being used to configure a processing node, at least some NVRAM settings have already been used by the BIOS or operating system, and therefore changing the NVRAM settings when configuring the processing node would have no effect. The result is that different processing nodes can have different NVRAM settings, causing some applications to execute differently on some processing nodes than on others. What is needed is a way of also automatically deploying NVRAM settings for a processing node when automatically deploying a PAN using a deployment specification.

### SUMMARY OF THE INVENTION

Embodiments of the invention for deploying a processing resource in a configurable platform are described. Embodiments of the invention include providing a specification that describes a configuration of a processing area network, the specification including (i) a number of processors for the processing area network (ii) a local area network topology defining interconnectivity and switching functionality among the specified processors of the processing area network, and (iii) a storage space for the processing area network. The specification further includes processing resource specific persistent settings. Embodiments of the invention further include allocating resources from the configurable platform to satisfy deployment of the specification, programming interconnectivity between the allocated resources and processing resources to satisfy the specification, and deploying the specification to a processing resource within the configurable deployment platform in response to software commands. The specification is also used to generate the software commands to configure the platform and then deploy processing resources corresponding to the specification.

Embodiments of the invention also include a processing resource pre-configured to perform a network boot, resulting in a secondary bootloader being downloaded and executed on the processing resource that installs in the processing resource at least one set of corresponding processing resource specific persistent settings. Other embodiments of the invention include downloading the application specific persistent settings from a control node, and sending a message to a control node that processing resource specific persistent settings have been installed. In response to the message, the control node establishes different connections to I/O resources for the at least one processing resource. Embodiments of the invention also include deploying a monitoring component for detecting changes to processing resource specific persistent settings. The monitoring component can record changes to the processing resource specific settings and transmit them to a control node of the configurable platform. The changes to the processing resource specific settings are used to update the specification that describes the configuration of a processing area network.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements:

FIG. 1 is a system diagram illustrating a reconfigurable virtual processing system.

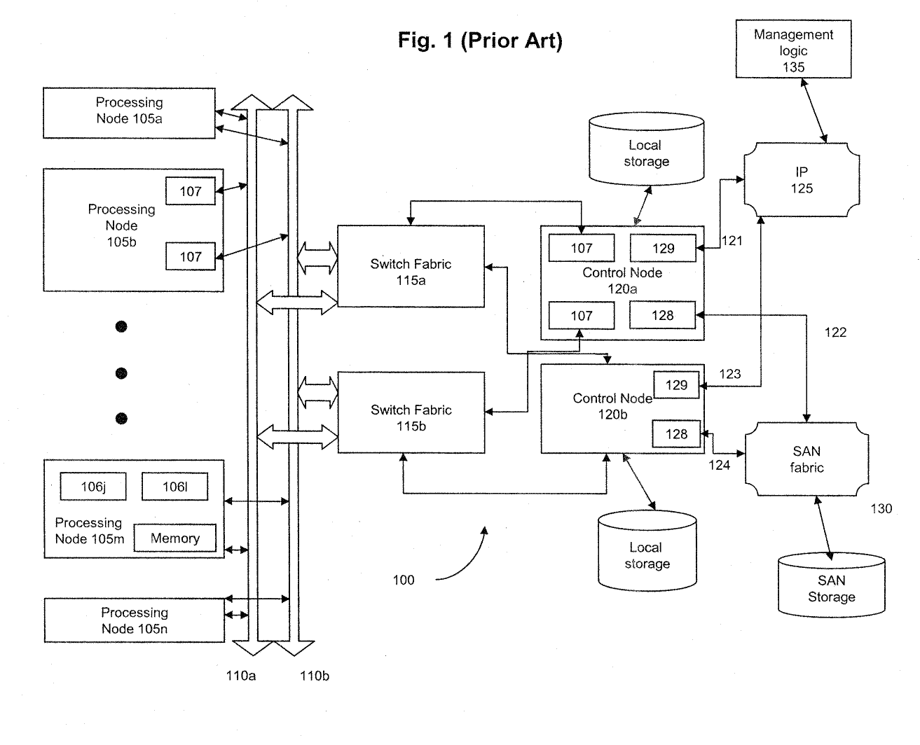

FIG. 2 is a system diagram illustrating storage of persistent settings within a general-purpose computer system.

FIG. 3 is a system diagram illustrating a reconfigurable virtual processing system with the ability to virtualize persistent settings.

FIG. 3A illustrates the organization of persistent settings in a database.

FIG. 4 is a block diagram illustrating how persistent settings are installed into a processing resource.

FIG. 5 is a flow diagram illustrating the process for installing persistent settings into a processing resource.

FIG. 6 is a flow diagram illustrating the process for modification of persistent settings by applications on a processing resource, and use of these modifications during subsequent deployments and boots of the processing resource.

### DETAILED DESCRIPTION OF EMBODIMENTS OF THE INVENTION

PAN specifications contain mostly logical information, such as the number of nodes in a PAN, and the connectivity between nodes. Preferred embodiments of the invention now improve on systems and methods which had PAN specifications containing logical information, to now have PAN specifications also including persistent settings. These persistent settings are those pieces of information that are persistent and that are maintained even in the absence of power (e.g. NVRAM settings). These persistent settings form a part of the PAN's personality in the same way that logical settings do. Using a deployment specification having logical settings and persistent settings allows PANs to be more accurately deployed. Other embodiments of the invention allow not only deployment of these persistent settings, but modification of them by applications on a processing resource. These modifications can be recorded and maintained in the deployment specification for the processing resource, allowing them to be used during subsequent deployments and boots of the processing resource.

In accordance with embodiments of the invention, a configurable deployment platform with virtualization of both logical processing resources and persistent settings is described. This configurable deployment platform uses a server specification to instantiate processing area networks on platform resources. Further details of this deployment platform and of deployment specifications with logical information about a processing resource are described in, e.g., commonly owned U.S. Pat. No. 7,231,430 entitled “RECONFIGURABLE, VIRTUAL PROCESSING SYSTEM. CLUSTER, NETWORK AND METHOD,” which is hereby incorporated by reference in its entirety.

The systems and methods of the preferred embodiment of the invention store both logical settings and persistent settings within a deployment specification. For example, the deployment specification can contain settings such as:

processor configuration settings (e.g. hyperthreading, which increases the number of CPUs that the operating system can use to execute user application)

memory settings (e.g. error correcting code, including error correction code (ECC) error reporting)

network media access control (MAC) addresses

world wide names used with storage area networks (SANs)

SAN resource discovery and access settings (e.g. internet small computer system interface (iSCSI) challenge handshake authentication protocol (CHAP) secrets)

node interleaving (defines the way that memory accesses are mapped in a system with a non-uniform memory system).

performance features (e.g. whether hardware prefetch engine is enabled or not)

execute disable (whether data pages can be marked as executable)

virtualization extensions (controls whether a CPUs virtualization extensions are enabled for use by the operating system)

The deployment specification, which also contains many other settings, can be used by a control node to configure the processing resources within a PAN of the configurable deployment platform. This allows the system to quickly deploy a processing resource. The deployment of physical settings that are persistent within a processing resource allows a more accurate processor personality to be deployed, yielding a more consistent processing platform.

For example, hyperthreading and memory settings will be installed into processor's (emulated) NVRAM and will allow consistent and accurate execution of a deployed processing area network (PAN) even when the PAN is migrated to different instances of underlying hardware.

As another example, embodiments of the invention enable a secure way to distribute security sensitive settings for the processing resources. In the situation of storage settings, certain settings are needed for iSCSI access (e.g. discovery method, resource information (e.g. initiator and target names and/or addresses) as well as access keys (e.g. CHAP secret, private keys etc.)). Such settings need to be programmed into the NIC of the processing resource. By loading persistent settings from a control node through a private and secure communication channel, it can be ensured that the persistent settings can be applied before the switch fabric is reprogrammed and opened for general I/O. It can also be used to ensure that any stale settings programmed into the NVRAM of a device (e.g. iSCSI NIC) can be re-programmed before the general I/O is enabled by the control nodes.

In this application, persistent storage is used to refer generally to any persistent storage (e.g. non-volatile storage) that retains its memory in the absence of power. Examples are electrically programmable read only memory (EPROMS), electrically erasable programmable read only memory (EEPROMS), and “Flash” memory. These are sometimes generally referred to as NVRAM. In this application, persistent storage can also be used to refer to memory settings that are maintained using a back up power source (e.g. CMOS settings). Persistent storage is used by the processor and operating system to store settings such as MAC addresses, memory settings, and processor configurations, or a processing resource's name.

In a virtualized computing platform, one goal is to allow any physical processing resource to accept and run any application that may be assigned to it from time to time. Another goal is that the processing resource that accepts the application will run the application the same as another processing resource. In accordance with embodiments of the invention, all settings associated with a processing resource or the usage intended for a processing resource can be stored in the deployment specification.

The deployment specification can include applications to be deployed, routes to be programmed in the switch fabric (described below), the number of processors to allocate for the networks, and the operating system. In short, all the settings that would be needed to deploy a network of computers and corresponding applications. Because the processing resource can be configured automatically by the control node, this process is automated by use of a detailed deployment specification. The settings are installed at an early phase of deploying an application so that applications running on the processing resources run similarly regardless of which processing resource they are deployed on. For example, migration of a processing resource (and corresponding applications) from a failed system to another processing resource within the same platform could not be done in as an accurate manner without migration of persistent settings. Likewise, if work is being re-distributed on the platform, the execution will be more consistent.

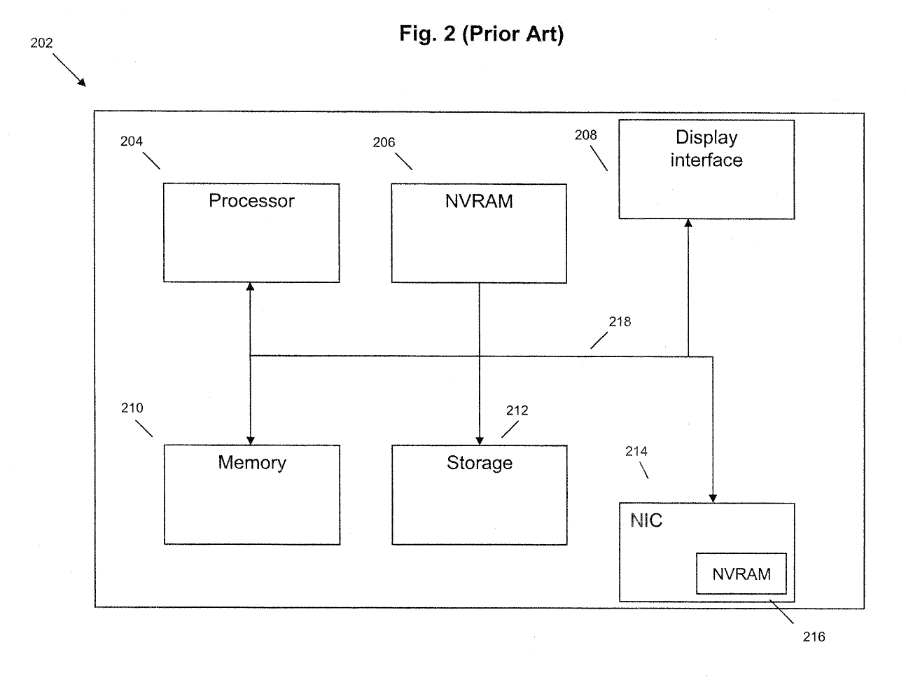

FIG. 2 is a system diagram of a computer system with persistent storage, in this embodiment, NVRAM. The computer system 202 has the standard components of a processor 204, memory 210, storage 212, network interface card (NIC) 214, and display interface 208. This system also has NVRAM 206 for storing persistent settings. All these components are connected to bus 218. In this system, NIC 218 also has its own internal NVRAM 216, that is accessible through the NIC and can be used to store information such as a MAC address.

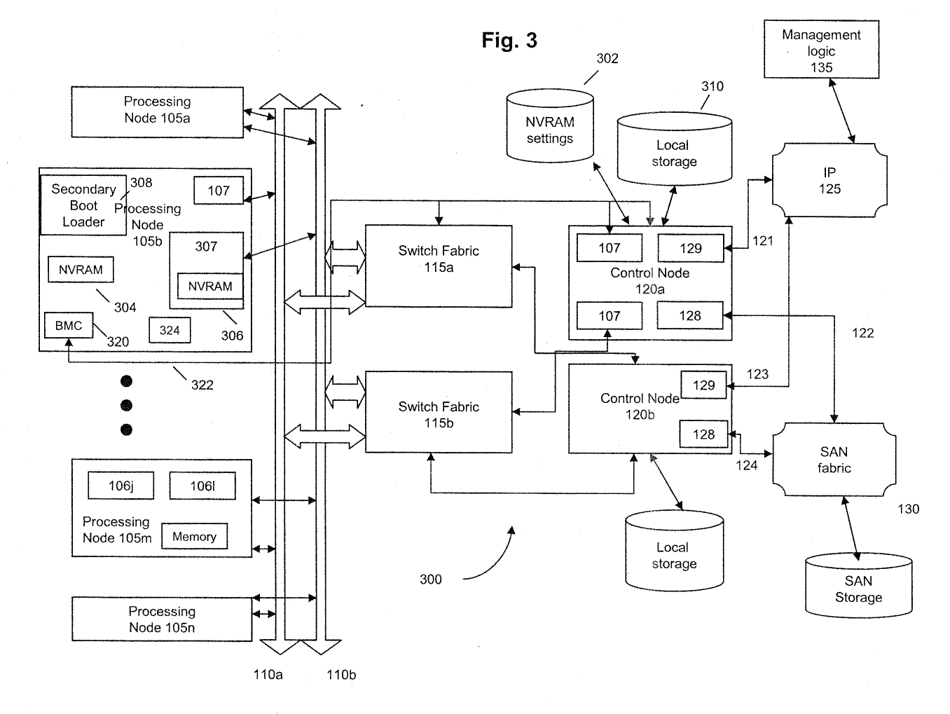

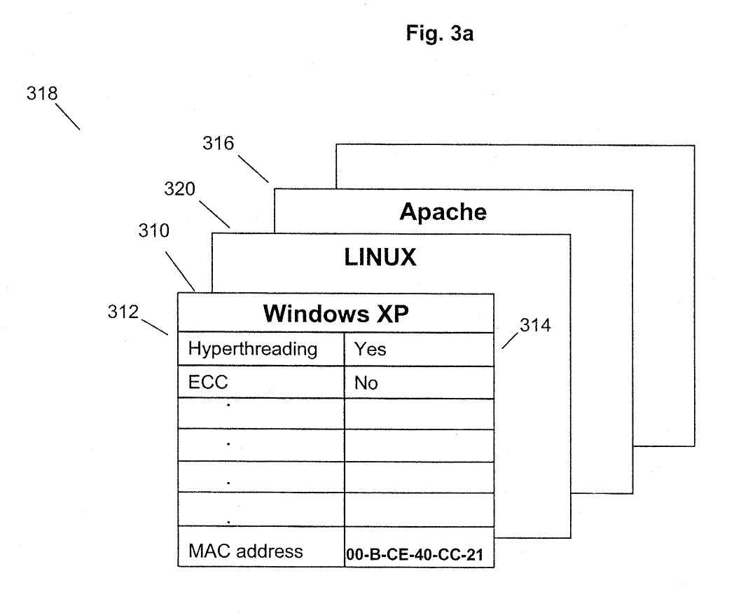

FIG. 3 is a system diagram of an embodiment of the invention that is able to deploy (and store) processing resource specific persistent settings. Processing resource (processing node) 105b contains general persistent settings 304 (shown as NVRAM) 304 and hardware component 307 specific persistent settings 306 (shown as NVRAM). In some embodiments of the invention, no actual persistent storage memory is used on the node 105, but instead the NVRAM is emulated with RAM and is loaded upon bootup.

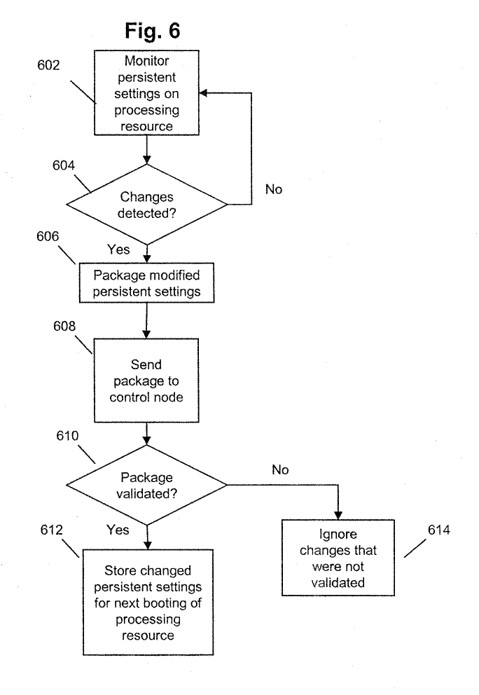

Also shown within processing resource 105b is monitoring component 324, which is further described with respect to FIG. 6. Monitoring component resides in operating system software booted by secondary bootloader 308, and it is used to monitors persistent settings for changes. Changes to the persistent setting are then packaged and sent back to control node 120a for future deployments of the processing resource and corresponding applications.

In the embodiment of the invention related to a bladeframe architecture, multiple processing resources are connected together with a high-speed network into a processing area network (PAN). A switch fabric with point-to-point links can be used between the processing resources to connect them together. A control node can also be connected to the switch fabric to control the multiple processing resources. To create and configure such networks, an administrator defines the network topology of a processing area network and specifies (e.g., via a utility within the management software 135) MAC address assignments of the various nodes in a deployment specification.

A secondary bootloader 308 is also shown within processing node 105b. The secondary bootloader actually installs persistent settings from the deployment specification into a processing resource and its components. The secondary bootloader is downloaded by processing node 105b during the boot up sequence. The bootloader is stored in local storage 310 of the control node, however it may also be stored in a database of persistent settings 302, or other remote storage.

Processing resources is also contains a baseboard management controller (BMC) 320 and an out-of-band management interface with a connection 322 back to control node 120a. Baseboard management controller can be used to monitor the node, for example, the temperature of components on the board, and report them back to another location such as control node. The out-of-band management interface allows communication with the BMC 320 over a communication link 322, such as a serial interface.

FIG. 3A shows details of a persistent setting database 302 organized in accordance with one embodiment of the invention. The database 302 can be organized as a number of tables 318, each table can be for a particular application, for example, Windows XP 310, LINUX 320, or Apache 316. The table contains a list of persistent setting variables 312, along with corresponding settings 314. A deployment specification for a particular PAN includes the settings for the corresponding applications to be executed on the processing resource, and may include settings from one or more tables. The deployment specifications can be generated using automatic tools, or through use of a text or graphical interface.

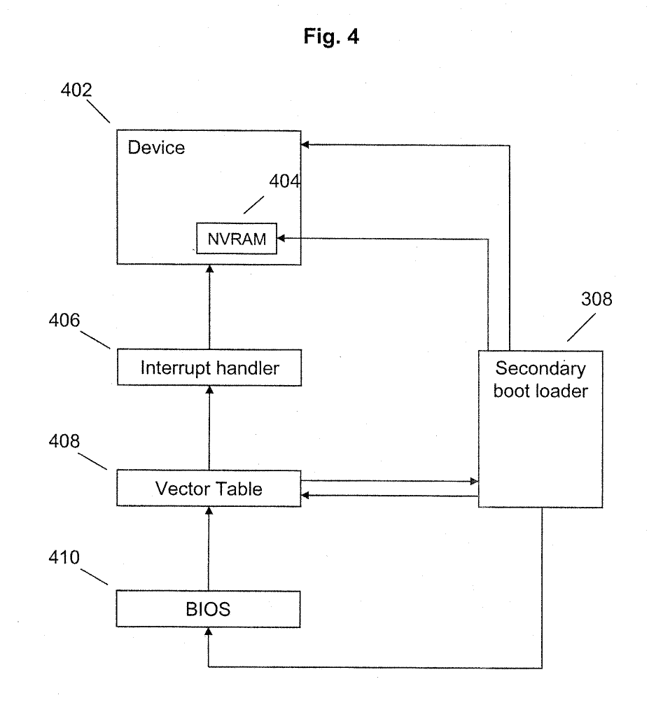

FIG. 4 is a block diagram illustrating the ways that persistent settings can be installed. Installation of persistent settings does not necessarily require changing of memory locations within an NVRAM storage device (e.g. rewriting EEPROM memory cells.) Although rewriting memory locations within an NVRAM storage device is one possible option, installing persistent settings only requires that the application being executed on processing node 105 receive values for those settings in an identical way, as if those persistent settings had been installed. The methods secondary bootloader 308 can use to accomplish this include, loading settings directly into the NVRAM of a hardware component 404, loading settings into the NVRAM of a hardware components through an interface provided by the component 402, by intercepting BIOS calls with special code 408, by using BIOS calls (e.g. through a BIOS application programming interface (API)) 410 to install settings, or by re-routing call for NVRAM setting to a memory location in RAM.

Secondary bootloader is executed on processing node 105, and either has contained within it the necessary persistent settings, or is programmed to download the necessary persistent settings from the control node. Bootloader 308 can access persistent settings over the network using the specially-programmed route to the control node that it was downloaded over.

Bootloader can install the persistent settings into the processing resource in multiple ways. A first method is to configure settings through the BIOS using a BIOS API, for example, one that is based on calling interrupt routines. These interrupt routines 406 can be called by the bootloader to have the BIOS perform specific functions, for example, rewriting certain NVRAM settings. By using BIOS functions 410 to load persistent settings for various system components, the bootloader program is simplified and portability is increased. However, the BIOS calls may themselves not actually rewrite NVRAM settings. Some computer systems copy NVRAM settings to RAM, and later BIOS requests access this RAM copy. Consequently, rewriting persistent settings through the BIOS may simply rewrite these RAM memory locations.

Another method that can be used by the secondary bootloader is to rewrite the interrupt vector table 408. By doing this, BIOS calls which use the vector table to determine which code to execute in response to a BIOS call can be intercepted and replaced with a different function. This can be used to rewrite BIOS functions that retrieve NVRAM settings. For example, when a BIOS call is made to request the MAC address of a NIC card, the request may be intercepted by code installed by the secondary bootloader. The secondary bootloader routine can return a value from a different memory location than the original BIOS call would have used, which has the same result as actually rewriting an NVRAM setting.

Another method that can be used by the bootloader to install persistent settings is to actually write NVRAM settings to the hardware component. This method relies on either a programmable interface to the component or a known sequence of signals that can achieve the desired result. For example, to turn on or off ECC in a memory component, a series of specifically timed bus signals can be used.

Another method that can be used by bootloader is to redirect request for NVRAM to locations in RAM. This can be done by placing the desired persistent settings in a location of RAM and then indicating to the system that the RAM location is NVRAM. This can either be done through editing the advanced configuration and power interface (ACPI) table or through modifying the system memory map in BIOS. When BIOS calls are made, the ACPI table will be used to retrieve the necessary persistent settings, which will result in the RAM memory location being read.

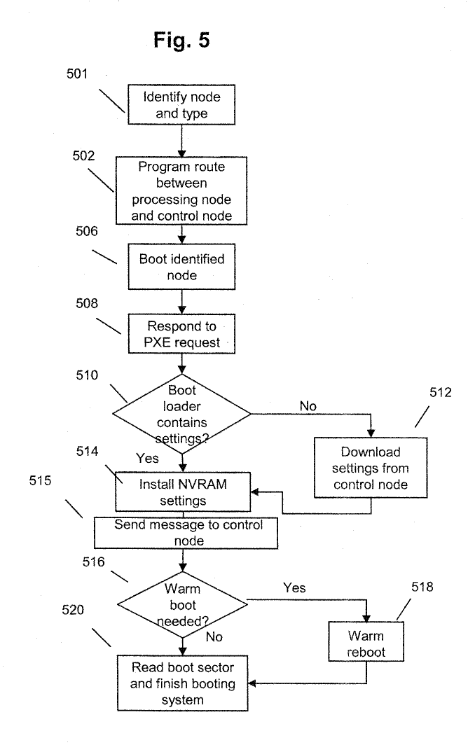

FIG. 5 is a flow diagram describing the process for installing persistent settings within a processing resource. Overall, an initial bootloader configured to perform a network boot is used to download a secondary bootloader, which then installs the desired persistent settings and finishes booting the processing node.

At step 501, an available node and its identity are determined. This begins when the virtualized computing platform's management software is instructed to instantiate a PAN to run an application. The management software, running on a control node, first chooses an idle physical processing resource on which to deploy the PAN consistently with the deployment specification. At step 502, the management software programs a single route through switch fabric 115a between itself and the available processing node, such as node 105b.

The processing node 105b is then booted at step 506. The processing node has its persistent settings preconfigured to perform a network boot. This allows the control node 120a the ability to respond and alter the boot process by having the secondary bootloader downloaded and executed.

During the initial network boot process, the processing node sends out a request for a bootloader to complete the boot process. This request can be done using many different protocols, such as, trivial file transfer protocol (TFTP) and preboot execution environment (PXE) protocol. For example, in PXE, the processing node sends out a broadcast packet requesting a bootloader from the network. A PXE server that is executing on control node responds that it will supply the necessary bootloader at step 508. Because there is only a single network route programmed between the processing node and the control node, it is ensured that the desired control node will be the node with a chance to respond.

After the bootloader has been downloaded, the processing node continues the boot process. At step 510, the bootloader determines if the necessary persistent settings are self-contained in the bootloader, or whether they need to be retrieved from the control node. At step 512, if the persistent settings need to be retrieved then they are downloaded from the control node. At step 514, the persistent settings are installed through one of the methods described with respect to FIG. 4. Alternatively, persistent setting can be downloaded from another location on the network which can be reached by a network route, including a different control node that where the bootloader was downloaded from.

When installation of all the settings has been performed, at step 515 the bootloader sends a message to management software on the control node. The message informs the management software to erase the special network route programmed from the processing node to the control node and instead program all the normal network and I/O routes that the intended application will use. This information is accessible to the control node in local storage.

At step 516, it is determined if a warm boot is needed after the installation of settings. This may be necessary for certain types of settings, for example, turning ECC on or off in main memory. At step 518, the warm boot is performed is necessary. At step 520, the bootloader completes the boot of the system by loading the IPL (Initial Program Load) code either from the disk (via the master boot record), DVD/CD-ROM (via El Torito), or from the network (via PXE). Once the IPL code is loaded, the bootloader will hand off execution to the IPL code which will complete the bootstrapping of the operating system.

In alternative embodiments, persistent settings can be installed using BMC 320, out-of-band management interface, and communication link 322. Before a processing node is rebooted, the desired persistent settings can be read from the deployment specification and deployed to the mailbox of the BMC 320. This is an area of memory within the BMC that has been allocated for this purpose and can be controlled by the control node 105b. Before the processing node is booted, the desired persistent settings are copied to the mailbox of the BMC through the communication link 322. Then, during the boot process for the processing node, the BIOS reads the mailbox memory area and configure the settings of the processing node in accordance with the settings.

FIG. 6 shows how persistent settings modified by applications on a processing resource can be sent back to a control node for use during subsequent deployment and boots. In some cases, the operating system or other software executing on a processing resource will change one or more persistent settings. To have these modifications to the persistent settings remain, even when processing resources are redeployed or rebooted, the modifications are sent back to the control node for storage along with the other persistent settings that are normally provided to a processing resource when it is deployed.

As described above with respect to FIG. 4, persistent settings can be installed into a processing resource through multiple methods. Applications executing on the processing resource locates and uses these persistent setting based on how they were installed. One way described above for installing NVRAM settings, is to redirect requests for NVRAM to locations in RAM through editing the ACPI table or modifying the system memory map in BIOS. Applications can then locate and access the installed NVRAM settings by using the BIOS system memory map, the ACPI table, or both.

For example, the BIOS system memory map and the ACPI table can be read by the operating system as it is booting. The BIOS system memory map and the ACPI table can also indicate which areas of the NVRAM are read only, or read/write. Once the NVRAM setting areas have been located, they can be read and written by applications, preferably in a way consistent with the read/write settings for the areas of NVRAM being accessed.

At step 602, as writes are being made to the NVRAM settings, the changes are monitored. Monitoring can be done by a software monitoring component 324 that is part of the operating system. This monitoring component 324 can be deployed from the control node during deployment of a PAN, or as part of the virtualization extensions that are installed during OS installation.

The monitoring component 324 monitors the NVRAM areas through different methods depending on whether the operating system or application software is performing the writes, and how those writes are made. The monitoring component intercepts operating system API calls which are intended to write to the NVRAM when such calls are supported by the operating system. When these API calls are intercepted, the call is allowed to pass through, enabling the write to happen, but the monitoring component also records the change in the persistent settings. For legacy operating systems that do not provide such API calls, the monitoring component regularly polls the NVRAM area for changes, comparing the NVRAM settings to the previously stored copies of persistent settings.

At step 604, when changes are detected, for example an API call has been intercepted or the polling has detected a change, the monitoring component packages up the modified NVRAM settings at step 606. These packages of modified persistent settings are sent back to a control node. If the monitoring component has not detected any changes, then the process moves back to step 602 to continue monitoring.

At step 608, the package of modified persistent settings is sent back to the control node. These modifications can be sent to the control node over the switch fabric, or the baseboard management controller interface. A secure protocol can be used to transfer the packaged modifications.

At step 610, the control node validates the package. For example, this can include ensuring that the package is properly formatted, the format of the data is correct, and checking that the modified persistent settings do not overwrite areas of the NVRAM memory that were not intended to be modified, or in any other way corrupt the NVRAM settings.

At step 612, after the package has been validated, the modifications are stored by updating the persistent settings database. The settings will then de deployed along with the other persistent settings the next time the processing resource and its corresponding applications are booted or deployed.

At step 616, if the package has not been validated, the modifications are ignored. Alternatively, the validated modifications are installed in persistent settings database, while the other modifications are ignored.

Although embodiments of the invention have been described in the context of deploying processing resources within a configurable deployment platform, for example a bladeframe system, embodiments of the invention can also be used to deploy persistent settings in other contexts. For example, embodiments of the invention can be used for installing persistent settings into a general-purpose computer system or specialized hardware device. This can be for operation of the device, or to prepare the computer or device to execute another application. Embodiments of the invention can be useful in any type of computer network where applications are deployed, for example, an enterprise computing network, a computing cluster, or distributed computing system.

While the invention has been described in connection with certain preferred embodiments, it will be understood that it is not intended to limit the invention to those particular embodiments. On the contrary, it is intended to cover all alternatives, modifications and equivalents as may be included in the appended claims. Some specific figures and source code languages are mentioned, but it is to be understood that such figures and languages are, however, given as examples only and are not intended to limit the scope of this invention in any manner.

What is claimed is:

1. A method of deploying a processing resource in a configurable platform comprising:
providing a specification that describes a configuration of a processing area network, including (i) a number of processors for the processing area network (ii) a local area network topology defining interconnectivity and switching functionality among the specified processors of the processing area network, and (iii) a storage space for the processing area network, wherein the specification further includes processing resource specific persistent settings;
allocating resources from the configurable platform to satisfy deployment of the specification;
programming interconnectivity between the allocated resources and processing resources to satisfy the specification;
deploying the specification to a processing resource within the configurable deployment platform in response to software commands; and
using the specification to generate software commands to the configurable platform to deploy processing resources corresponding to the specification.

2. The method of claim 1, wherein a processing resource is pre-configured to perform a network boot, resulting in a secondary bootloader being downloaded and executed on the processing resource, and wherein the secondary bootloader installs in the processing resource at least one set of corresponding processing resource specific persistent settings.

3. The method of claim 2 further comprising the step of:
reading the master boot record of a processing resource, and completing the boot process of the processing resource in accordance with the master boot record.

4. The method of claim 2, wherein the secondary bootloader is downloaded from a control node.

5. The method of claim 2, wherein the secondary bootloader downloads the application specific persistent settings from a control node.

6. The method of claim 2, further comprising sending a message to a control node that processing resource specific persistent settings have been installed, and wherein in response to the message, the control node establishes different connections to I/O resources for the at least one processing resource.

7. The method of claim 2, further comprising performing a warm boot before rebooting by reading at least one of a master boot record on a hard disk, a boot image from a DVD, and boot information from a network via PXE.

8. The method of claim 2, wherein configuring the processing resource with a set of processing resource specific persistent settings is done using BIOS calls.

9. The method of claim 2, wherein configuring the processing resource with a set of processing resource specific persistent settings is done by intercepting BIOS calls.

10. The method of claim 2, wherein configuring the processing resource with a set of processing resource specific persistent settings is done by directly writing persistent settings to a hardware component.

11. The method of claim 2, wherein generating software commands to the configurable platform to deploy processing resources corresponding to the specification comprises: programming settings from the specification into NVRAM of a processing resource.

12. The method of claim 1, further comprising:
deploying a monitoring component for detecting changes to processing resource specific persistent settings.

13. The method of claim 12, wherein the monitoring component records changes to the processing resource specific settings and transmits them to a control node of the configurable platform, wherein the changes to the processing resource specific settings are used to update the specification that describes a configuration of a processing area network.

14. The method of claim 13, wherein the updated specification that describes a configuration of a processing area network is used for deploying at least one processing resource within the configurable deployment platform.

15. The method of claim 2, wherein the processing resource specific persistent settings installed by the secondary bootloader are downloaded from a memory area of a baseboard management controller using an out-of-band management interface.

16. A system for deploying a processing resource in a configurable platform comprising:
a specification that describes a configuration of a processing area network, including (i) a number of processors for the processing area network (ii) a local area network topology defining interconnectivity and switching functionality among the specified processors of the processing area network, and (iii) a storage space for the processing area network, wherein the specification further includes processing resource specific persistent settings;
programmed interconnectivity between the allocated resources and processing resources to satisfy the specification; and
allocated resources from the configurable platform to satisfy deployment of the specification, wherein the specification is deployed to a processing resource within the configurable deployment platform in response to software commands, and wherein the specification is used to generate software commands to the configurable platform to deploy processing resources corresponding to the specification.

17. The system of claim 16, wherein a processing resource is pre-configured to perform a network boot, resulting in a secondary bootloader being downloaded and executed on the processing resource, and wherein the secondary bootloader installs in the processing resource at least one set of corresponding processing resource specific persistent settings.

18. The system of claim 17, wherein the secondary bootloader downloads the application specific persistent settings from a control node.

19. The system of claim 17, further comprising: a control node receiving a message that processing resource specific persistent settings have been installed, and wherein in response to a received message, the control node establishes different connections to I/O resources for the at least one processing resource.

20. The system of claim 17, wherein the processing resource is configured with a set of processing resource specific persistent settings using BIOS calls.

21. The system of claim 17, wherein the processing resource is configured with a set of processing resource specific persistent settings by intercepting BIOS calls.

22. The system of claim 16, further comprising:
a monitoring component, deployed to a processing resource, for detecting changes to processing resource specific persistent settings.

23. The system of claim 22, wherein the monitoring component records changes to the processing resource specific settings and transmits them to a control node of the configurable platform, wherein the changes to the processing resource specific settings are used to update the specification that describes a configuration of a processing area network.

24. The system of claim 23, wherein the updated specification that describes a configuration of a processing area network is used for deploying at least one processing resource within the configurable deployment platform.

25. The system of claim 24, wherein the processing resource specific persistent settings installed by the secondary bootloader are downloaded from a memory area of a baseboard management controller using an out-of-band management interface.
